(19) United States
(12) Patent Application Publication
(10) Pub. No.: US 2008/0269054 A1
(43) Pub. Date: Oct. 30, 2008

(54) Preparation Containing Uv Radiation Absorbing Metal Oxide Powder and a Superspreading Agent

(75) Inventors: Ingo Fleute-Schlachter, Essen (DE); Ewald Sieverding, St. Johann (DE); Wolfgang Lortz, Waechtersbach (DE); Jochen Scheffler, Alzenau (DE); Kai Schumacher, Hofheim (DE); Reinhard Vormberg, Neuberg (DE)

Correspondence Address: OBLON, SPIVAK, MCCLELLAND MAIER & NEUSTADT, P.C., 1940 DUKE STREET, ALEXANDRIA, VA, 22314, US

(73) Assignee: Evonik Degussa GmbH, Essen (DE)

(21) Appl. No.: 11/996,598

(22) PCT Filed: Jul. 11, 2006
(86) PCT No.: PCT/EP2006/064080

§ 371 Date: Jul. 18, 2008

(30) Foreign Application Priority Data
Jul. 28, 2005 (DE) 10 2005 035 309.6

(51) Int. Cl. A01N 59/16; A01P 21/00

(52) U.S. Cl. 504/121

(57) ABSTRACT

Preparation containing at least one UV radiation absorbing metal oxide powder and at least one superspreading agent. Use of the preparation for the reduction of sunburn damage in useful plants.

The invention relates to a preparation which contains a UV-radiation absorbing metal oxide powder and a superspreading agent. The invention further relates to the production and use of the preparation for the reduction of sunburn damage in plants.

In the Journal of Applied Botany, 77 (2003), pages 75-81, Schmitz-Eiberger et al. reported on the reduction of sunburn damage in useful plants through the use of zinc oxide. Here white zinc oxide was used in a dispersion with lecithin. It was found that the sunburn damage decreased only marginally in comparison to an untreated sample. Also a disadvantage is the fact that with this treatment parts of the plants are covered with a white layer of zinc oxide, whereas other plant parts are not covered at all.

The purpose of the invention is to provide a preparation with the use whereof sunburn damage on useful plants can be further reduced compared to the state of the technology. A uniform, transparent covering of the plant parts is especially desirable.

The problem is solved by means of a preparation which contains at least one UV radiation absorbing metal oxide powder, wherein the specific surface area of the metal oxide powder is at least 20 m²/g and the preparation contains at least one superspreading agent.

Superspreading agents in the sense of the invention should be understood to mean agents which lower the surface tension of water to values below 35 mN/m and which in aqueous solutions at a concentration of 0.1% or less form a thin film on a hydrophobic surface within seconds (Definition based on S. Zhu et. Al. In Colloids Surfaces A: Physicochem. Eng. Aspects, 1994, 63-78). Hydrophobic surfaces should be understood to mean leaves and plants which are for example used agriculturally and horticulturally or the harvested products therefrom.

A UV radiation absorbing metal oxide powder can also reflect UV radiation.

The specific surface area, determined as per DIN 66131, of the metal oxide powder is at least 20 m²/g. Below 20 m²/g, the sun protection action is too small. Preferably, the preparation according to the invention contains metal oxide powders with a specific surface area of 40 to 100 m²/g. Metal oxide powders with specific surface areas of 200 to 300 m²/g can also be used. However, these metal oxide powders display only the same or only a slightly higher sun protection action as metal oxide powders with a specific surface area of 40 to 100 m²/g.

The liquid phase of the preparation according to the invention can be aqueous, that is, the main component is water. Further, the liquid phase can be organic, the main component is an organic compound.

The content of UV radiation absorbing metal oxide powder and superspreading agent in the preparation according to the invention is preferably in each case 0.001 to 70 wt. %, based on the preparation, wherein the contents of UV radiation absorbing metal oxide powder and superspreading agent are mutually independent.

In order to save costs, as high as possible a content of UV radiation absorbing metal oxide powder and superspreading agent will be preferred for the transportation of the preparation according to the invention. In particular, it is advantageous when for this purpose the content of UV radiation absorbing metal oxide powder is 25 to 50 wt. %. In this range, metal oxide dispersions as a rule still display adequate stability against sedimentation and/or reagglomeration.

For use as sun protection agents, however, as low as possible a content of UV radiation absorbing metal oxide powder and superspreading agent is the aim. Preferred for this use is a preparation according to the invention whose content of UV radiation absorbing metal oxide powder is 0.02 to 1.5 wt. % and that of superspreading agent 0.01 to 1.0 wt. %.

Furthermore, it can be advantageous when the mean particle diameter of the UV radiation absorbing metal oxide powder in the preparation is lower than 1000 nm. Particularly advantageous is a mean particle diameter of less than 200 nm. With these values, the coating on the treated parts of the plants appears extremely or completely transparent. Further, the sun protection action is particularly high.

The UV radiation absorbing metal oxide powders present in the preparation according to the invention can be in aggregated, partially aggregated or non-aggregated form. Surprisingly, aggregated powders have been found to be particularly effective.

Moreover, UV radiation absorbing metal oxide powders which have no internal surface have been found to be particularly effective.

The UV radiation absorbing metal oxide powder can preferably be a titanium oxide powder, a zinc oxide powder, a mixed oxide powder with the components titanium, zinc, zirconium, aluminium and/or silicon, a crystal lattice-doped titanium oxide powder or zinc oxide powder, in particular doped with manganese, iron or vanadium, a surface modified titanium oxide or zinc oxide powder or a mixture of the aforesaid compounds. The surface modification can be of an inorganic nature, for example the oxides of silicon, aluminium or zirconium. The surface modification can also be of an organic nature, for example modification with fatty acids such as stearates or organic silanes.

Further, with preparations according to the invention which contain titanium oxide powder, it is advantageous when this contains rutile and anatase phases. In these, the anatase form should predominate. A ratio of rutile to anatase of 30/70 to 10/90 is suitable. In rutile, the gap between valence and conduction band is about 3.05 eV, corresponding to an absorption at 420 nm, which is still in the visible range of 400 to 750 nm. In anatase, the gap is 3.20 eV, corresponding to an absorption at 385 nm, i.e. in the ultraviolet radiation range.

Particularly advantageous is a preparation according to the invention wherein the UV radiation absorbing metal oxide powder can be obtained by flame hydrolysis or flame oxidation. In flame oxidation, a metal oxide precursor or a mixture of metal oxide precursors is oxidised with oxygen with the formation of the metal oxide or metal mixed oxide powder. In flame hydrolysis, the formation of the metal oxide or metal mixed oxide powder takes place by hydrolysis of the metal oxide precursor or precursors, the water necessary for the hydrolysis being derived from the combustion of a fuel gas, for example hydrogen, and oxygen. By way of example, the equations 1a and 1b describe the formation of titanium oxide via flame oxidation (Eq. 1a) and flame hydrolysis (Eq. 1b).

TiCl₄+O₂−>TiO₂+2Cl₂ (Eq. 1a)

TiCl₄+2H₂O−>TiO₂+4HCl (Eq. 1b)

Particularly advantageous are preparations according to the invention, wherein the UV radiation absorbing metal oxide powder contains titanium oxide or consists thereof and was produced by flame hydrolysis.

In particular, this can be a titanium dioxide powder, which has a specific surface area (BET surface area) of 20 to 200 m²/g and a primary particle distribution half value width HW between HW [nm]=a×BET^{f} with a=670×10⁻⁹ m³/g and −1.3≦f≦−1.0 and wherein the content of particles with a diameter of more than 45 μm lies in a range from 0.0001 to 0.05 wt. %.

Preferably, the titanium oxide powders can be TiO₂-1 and TiO₂-2 with the following characteristics:

| | | TiO₂-1 | TiO₂-2 |
|---|---|---|---|
| Specific surface area | m²/g | 40-60 | 80-120 |
| Primary particle diameter* | nm | 10-40 | 4-25 |
| Equivalent circular diameter | nm | <80 | <70 |
| (ECD) of aggregates | | | |
| Mean aggregate area | nm² | <6500 | <6000 |
| Mean aggregate size | nm | <450 | <400 |

| | | |
|---|---|---|
| Aggregates/agglomerates >45 μm | wt. % | 0.002-0.005 |
| Rutile/anatase | | 20:80-5:95 |

*90% range, numerical distribution

These powders and the production thereof are described in the still unpublished German patent application with the application number 102004055165.0 and the application date 16 Nov. 2004.

As well as the UV radiation absorbing metal oxide powder, the preparation according to the invention contains as an essential component at least one superspreading agent.

Preferably, the preparation according to the invention can contain polyether-modified polysiloxanes, polyether-modified silane surfactants or fluoro surfactants as superspreading agents.

Here, polyether-modified polysiloxanes of the general formula

R₃—Si—[OSiRR¹]ₙ—O—SiR₃

wherein
R is an alkyl residue with 1 to 6 carbon atoms,
R¹ has the structure -Z-O—R² and Z is a divalent, optionally branched alkylene residue with 2 to 6 carbon atoms in the alkylene chain,
R² is a residue of the formula (CₘH₂ₘO—)ₛR³, wherein m is a number>2.0 and ≦2.5, s a number from 4 to 21 and R³ a hydrogen residue, an alkyl residue with 1 to 4 carbon atoms or an acetyl residue, and
n is a number from 1 to 4,
can be particularly preferred.

Suitable, commercially available superspreading agents can be:

Sylgard® 309 from Dow Corning, MI, USA, a polyether-modified trisiloxane surfactant, wherein the polyether is built up only of units of ethylene oxide (EO) and this has an acetyl end closure,
Silwet® L-77 from GE/OSi, CT, USA, a polyether-modified trisiloxane surfactant, wherein the polyether is built up only of units of EO this has a methyl end closure,
Silwet® 408 from GE/OSi, CT, USA, a polyether-modified trisiloxane surfactant, wherein the polyether is built up only of units of EO,
BREAK-THRU® 240 from Goldschmidt GmbH, Germany, a polyether-modified trisiloxane surfactant, wherein the polyether is built up of units of ethylene oxide and propylene oxide,
Bayowet® FT 248 from Lanxess AG, Germany, a fluoro surfactant based on tetraethylammonium heptadecafluoro-octanesulphonate.

In addition, the preparation according to the invention can contain additives such as are known to the skilled person for the stabilisation of dispersions against sedimentation or reagglomeration. These can for example be pH regulators, such as carboxylic acids, dicarboxylic acids, hydroxy-carboxylic acids or mineral acids and/or salts thereof. Further, the preparation according to the invention can contain phosphates, polyphosphates, polyacrylic acids and salts thereof, cationic polymers and/or amino alcohols.

A further object of the invention is a process for the production of the preparation according to the invention wherein
a dispersion with a UV radiation absorbing metal oxide powder content of up to 75 wt. %, which can optionally be stabilised by addition of pH regulators or surfactant substances,
is added with stirring to a superspreading agent and optionally water, until the desired content of metal oxide powder and superspreading agent is in the range from 0.001 to 70 wt. %.

A further object of the invention is the use of the preparation according to the invention for the reduction of sunburn damage in useful plants.

### EXAMPLES

### Preparations

A preparation according to the invention is obtained by mixing a titanium oxide dispersion with a superspreading agent.

The titanium oxide dispersion has a titanium oxide content of 35 wt. %. In addition, it contains 21 wt. % of a poly-acrylic acid and 46 wt. % of water.

The titanium oxide used is a pyrogenically produced, aggregated titanium oxide powder with a BET surface area of 50 m²/g.

As the superspreading agent, BREAK-THRU© S 240, Goldschmidt GmbH, is used.

For the treatment of the plants, the titanium oxide dispersion A is adjusted with water to concentrations of 0.33 (preparation A1) and 0.1 (preparation A2) wt. %. Further, a quantity of superspreading agent is added, such that the content thereof in both preparations (A1 and A2) is about 0.041 wt. % in each case. Both preparations A1 and A2 are sprayed onto the plants as aqueous solutions, corresponding to a water requirement of 300 litres/ha.

The measurements were performed in comparison with an untreated control (as negative modification) and in comparison with a modification treated with a methoxycinnamic acid derivative (as positive modification).

### Plant Species

The tests were performed on bean plants (Phaseolus vulgaris) at the two-leaf stage and also on barley.

### Methods

For the measurement of the sunburn-reducing action, the plants were exposed under controlled conditions to a UV-B radiation dose which causes clear damage in the untreated control. A potential decrease of the UV blocker was investigated in comparison to the untreated control (negative control) and compared with the results for the methoxycinnamic acid modification (positive control). The damage caused to the plants by UV-B sunburn was scored 24 hours and 48 hours after the irradiation, by a procedure usual at the Institute of Fruit Farming (for this, see the procedure in the periodical Journal of Applied Botany, 77 (2003), pages 75-81). In this, the maximum damage is given the score 3, and the value 0 is awarded when the plants are not damaged.

### Results

### Beans

No decrease in the photosynthetic capacity of the bean leaves could be found after treatment with the preparations A1 or A2. Measurements of the photosynthetic capacity on bean leaves showed no significant differences in comparison with the untreated control.

Scoring of the UV damage after treatment of the bean leaves showed significant damage in the untreated control. The UV-B induced damage was most markedly reduced after pre-treatment of the plants with preparation A1.

On use of preparations A1 and A2 each in combination with Break-Thru S240, the bean leaves were less damaged than in the negative control, which points to a clear protective effect of the preparations against UV-B induced damage.

### Barley

In barley, no decrease in the photosynthetic capacity after UV-B exposure of the plants was found compared to the untreated control, when the plants had been treated with the preparations A1 and A2.

Scoring of the UV damage after treatment of the plants with UV-B radiation also showed significant damage in the unprotected/untreated control in barley. The UV-B induced damage was most markedly reduced on pretreatment of the plants with preparation A1.

### Outcome:

The application of the preparation according to the invention does not hinder photosynthesis by the plants.
A decrease in UV induced damage is achieved by application of the preparation according to the invention.
On use of the preparation according to the invention, the coating on the treated parts of the plants appears extremely or completely transparent.

TABLE 1
Results with bean leaves

| | Photosynthetic | | |
|---|---|---|---|
| | capacity | UV-induced damage*⁾ | |
| Preparation | [μmol/m²/sec] | after 24 hrs | after 48 hrs |
| A1 | 1.60 ± 0.13 | 1.125 | 1.125 |
| A2 | 1.78 ± 0.09 | 1.5 | 1.5 |
| Positive control | 1.84 ± 0.16 | 1.375 | 1.375 |
| Negative control | 1.78 ± 0.19 | 2.075 | 1.875 |

TABLE 2
Results with barley

| | Photosynthetic | | |
|---|---|---|---|
| | capacity | UV-induced damage*⁾ | |
| Preparation | [μmol/m²/sec] | after 24 hrs | after 48 hrs |
| A1 | 1.42 ± 0.16 | 1.625 | 1.425 |
| A2 | 1.38 ± 0.41 | 2.125 | 1.975 |
| Positive control | 1.3 ± 0.30 | 1.5 | 1.25 |
| Negative control | 1.3 ± 0.14 | 2.25 | 2.0 |

*⁾Scores:
0 = no damage, 1 = mild, 2 = moderate, 3 = severe damage.

1: A preparation comprising at least one UV radiation absorbing metal oxide powder, wherein the specific surface area of the metal oxide powder is at least 20 m²/g and the preparation comprises at least one superspreading agent.

2: The preparation according to claim 1, wherein the content of UV radiation absorbing metal oxide powder and superspreading agent is mutually independently 0.001 to 70 wt. %, based on the preparation.

3: The preparation according to claim 2, wherein the content of UV radiation absorbing metal oxide powder is 25 to 50 wt. %.

4: The preparation according to claim 2, wherein the content of UV radiation absorbing metal oxide powder is 0.02 to 1.5 wt. % and of superspreading agent is 0.01 to 1.0 wt. %.

5: The preparation according to claim 1, wherein a mean particle diameter of the metal oxide powder in the preparation is less than 1000 nm.

6: The preparation according to claim 1, wherein the UV radiation absorbing metal oxide powder is in the form of aggregated primary particles.

7: The preparation according to claim 1, wherein the UV radiation absorbing metal oxide powder has no internal surface.

8: The preparation according to claim 1, wherein the UV radiation absorbing metal oxide powder is a titanium dioxide powder, a zinc oxide powder, a mixed oxide powder with the components Ti, Zn, Al and/or Si, a crystal lattice-doped titanium oxide powder or zinc oxide powder and/or a surface-modified titanium dioxide powder or zinc oxide powder.

9: The preparation according to claim 1, wherein the titanium oxide fraction has a rutile phase and an anatase phase.

10: The preparation according to claim 1, wherein the superspreading agent contains comprises a poly-siloxane of the general formula
R₃—Si—[OSiRR¹]ₙ—O—SiR₃
wherein
R is an alkyl residue with 1 to 6 carbon atoms,
R¹ has the structure -Z-O—R² and Z is a divalent, optionally branched alkylene residue with 2 to 6 carbon atoms in the alkylene chain,
R² is a residue of the formula (CₘH₂ₘO—)ₛR³ wherein m is a number>2.0 and ≦2.5, s a number from 4 to 21 and
R³ is a hydrogen residue, an alkyl residue with 1 to 4 carbon atoms or an acetyl residue, and
n is a number from 1 to 4.

11: The preparation according to claim 1, wherein the preparation further comprises normal additives for the stabilisation of dispersions.

12: A process for the production of the preparation according to claim 1, comprising:
adding together with stirring
a dispersion with a UV radiation absorbing metal oxide powder content of up to 75 wt. %, which can optionally be stabilised by addition of pH regulators or surfactant substances, and
a superspreading agent and optionally water, until the desired content of metal oxide powder and superspreading agent is in the range from 0.001 up to 70 wt. %.

13. (canceled)

14: A method for the reduction of sunburn damage to useful plants comprising covering plant parts with the preparation according to claim 1.
